(19) United States
(12) Patent Application Publication
(10) Pub. No.: US 2022/0098070 A1
(43) Pub. Date: Mar. 31, 2022

(54) METHODS FOR TREATING WASTE ACTIVATED SLUDGE

(71) Applicant: FLUENCE WATER PRODUCTS AND INNOVATION LTD, Caesarea (IL)

(72) Inventors: Ronen Itzhak SHECHTER, Tel Aviv (IL); Lotan DAGAI, Pardes Hanna (IL); Yedidya HEFFES, Mehola (IL)

(73) Assignee: FLUENCE WATER PRODUCTS AND INNOVATION LTD, Caesarea (IL)

(21) Appl. No.: 17/424,945

(22) PCT Filed: Jan. 22, 2020
(86) PCT No.: PCT/IL2020/050086

§ 371 Date: Jul. 22, 2021

Related U.S. Application Data
(60) Provisional application No. 62/796,095, filed on Jan. 24, 2019.

(51) Int. Cl. C02F 3/20; C02F 3/00; C02F 3/10; C02F 3/30; C02F 3/22

(52) U.S. Cl. CPC C02F 3/208; C02F 3/006; C02F 3/102; C02F 2209/14; C02F 3/223; C02F 2209/04; C02F 2209/15; C02F 3/301

(57) ABSTRACT

A method of treating waste activated sludge. More specifically, the disclosure concerns treating waste activated sludge by a membrane aerated sludge digester to reduce of volatile soluble solids (VSS) concentration in the sludge to obtain aerobically treated sludge.

### TECHNOLOGICAL FIELD

The present disclosure concerns methods of treating waste activated sludge. More specifically, the disclosure concerns treating waste activated sludge by a membrane aerated sludge digester.

### BACKGROUND ART

References considered to be relevant as background to the presently disclosed subject matter are listed below:
WO 2004/071973
WO 2011/073977
WO 2012/081001
WO 2016/038606
WO 2016/108227

Acknowledgement of the above references herein is not to be inferred as meaning that these are in any way relevant to the patentability of the presently disclosed subject matter.

### BACKGROUND

Wastewater treatment systems often produce activated sludge as a by-product during the water treatment process. Before discharging to the environment, such activated sludge is required to be further treated, e.g. stabilized.

Typically, waste activated sludge is collected from various treatment systems, such as primary and/or secondary treatment systems, as well as from clarifiers. Primary sludge comprises untreated solids in suspension in wastewater, and is typically rich in organic material, which is by large readily bio-degradable. Secondary activated sludge, that consists of biomass and suspended treated particulate matter in treated wastewater (effluent), has lower calorific value and is less easily bio-degradable compared to primary sludge. As such waste activated sludges often comprise a large amount of biomass, including pathogens, it needs to be treated before releasing to the environment.

One treatment process that is typically used is the addition of various chemicals to the waste sludge, to form a chemical reaction that reduces the amount of active biomass in the sludge. The chemicals used in such processes, e.g. lime or similar materials, may by themselves pose an environmental hazard.

Other treatment processes for activated sludge are aerobic and anaerobic biological digestions. In anaerobic sludge digestion, oxygen supply is not required, hence little power is consumed, and biogas is produced. Therefore, anaerobic digestion is typically energy neutral or positive, and hence is often used. However, anaerobic digestion involves relatively expensive equipment, imposes explosive hazard (due to the formation of gaseous by-products) and is complicated to operate.

Aerobic digestion is simpler to install and operate, and may produce higher quality supernatant by also removing nitrogen that is released during sludge treatment. However, aerobic digestion is a process that typically consumes high energy, as continuous and intensive aeration of the sludge is required during the process until the sludge is stabilized by endogenous decay.

### GENERAL DESCRIPTION

The present disclosure provides a low-energy consumption method for treating waste activated sludge by inducing aerobic conditions in a sludge-containing medium. The low energy consumption is obtained by the use of oxygen-permeable water-impermeable membranes, which consume less energy than other aerobic treatment methods while providing a high treatment efficiency in a relatively compact arrangement. Compared to standard aerobic treatments, the use of such membranes may cause reduction in energy consumption of the treatment facility by as much as 80%.

By an aspect of this disclosure, there is provided a method for treating waste activated sludge (WAS), the method comprises feeding WAS into a treatment tank, the WAS having an initial volatile suspended solids (VSS) concentration, the treatment tank being fitted with one or more oxygen-permeable water-impermeable membranes, said membranes being configured for supporting biofilm growth thereon; feeding an oxygen-containing gas into said one or more oxygen-permeable water-impermeable membranes to provide oxygen to at least a portion of the biofilm, while maintaining the WAS under anoxic condition; and mixing the WAS in the tank to cause circulation thereof in proximity to the one or more oxygen-permeable water-impermeable membranes and retaining the WAS in the tank for a period of time permitting substantial reduction of said initial VSS concentration, thereby obtaining an aerobically treated sludge.

Waste activated sludge (WAS) means to denote a by-product of wastewater treatment processes, and is typically the excess activated sludge that is removed from the wastewater treatment process in order to maintain the system's balance. As noted above, the WAS is typically rich in active biomass, and hence needs to be further treated before release to the environment. WAS may be obtained from wastewater treatment processes/facilities, or from primary and/or secondary clarifiers.

In some embodiments, the WAS may be diluted with a carrier medium (e.g. water). In other embodiments, the WAS may be concentrated and/or thickened WAS.

One of the characteristics of WAS that determines whether the sludge is safe for release to the environment is the volatile suspended solids (VSS) concentration, which is a measure of water quality and represents the amount of volatile matter present in the solid fraction of WAS. WAS is considered unsafe for release in case the VSS concentration exceeds a threshold value, which differs from one country to the another according to local environmental standards and Regulations. Hence, the methods of this disclosure aim at treating the WAS in order to reduce its VSS concentration sufficiently to enable safe disposal of the sludge after treating. Such a process is also known as stabilization of sludge.

In the methods of this disclosure, WAS is treated in one or more membrane-aerated biofilm reactor (MABR) modules, each of said modules comprises one of said one or more oxygen-permeable water-impermeable membranes. The MABR modules are fitted within the treatment tank, and occupy at least a portion of the tank's volume. The one or more oxygen-permeable water-impermeable membranes are configured for supporting and growth of biofilm. The oxygen-permeable water-impermeable membrane is connected to an oxygen-containing gas source (e.g. air), and configured to diffusively transfer oxygen through the membrane walls toward a water-facing surface of the membrane walls. The water-facing surface provides support for the formation and development of biofilm on at least a portion of the water-facing surface of the membrane, which is fed by oxygen that diffuses through the membrane.

The number of membranes (or modules) and their dimensions may vary depending on the amount of WAS to be treated and/or the volume of the treatment tank. Generally speaking, the number of membrane or modules will typically be proportional to the daily volume/amount of WAS that is to be treated by the process.

Oxygen-permeable water-impermeable membranes may have various suitable configurations. By one example, the membranes may be flat sheet membranes, such as those described in international patent application WO 2016/038606. In another example, the at least one membrane may be wound about a longitudinal axis of the tank to form a spirally-wound membrane sleeve. The membranes may, by another example, be in the form of folded or pleated sheets. Alternatively, membranes may be hollow fiber membrane, such as those described in international patent applications WO 2016/108227 and WO 2004/071973. The membranes may be spaced from one another by one or more spacers.

The WAS is treated in a manner to be described below by contacting with the biofilm. Oxygen is transferred through the membrane to the biofilm by diffusion, thus enables operating the MABR module at an oxygen-containing gas pressure that is lower than the hydrostatic pressure of the medium in the tank. This, in turn, reduces the overall energy consumption of the system.

The oxygen-containing gas may be fed to the at least one membrane continuously, intermittently, or periodically.

After WAS is fed into the treatment tank, it is maintained in the tank under anoxic conditions, and is retained in the tank for a period of time that is sufficient to reduce the VSS concentration. During the retention of the WAS in the tank, at least some of the solids undergo hydrolysis, causing release of soluble ammonium compounds, organic material and residual inert solids. In other words, as the WAS is maintained in the tank under anoxic conditions, it hydrolyses to produce soluble organic material and ammonium compounds. The ammonium compounds are nitrified by the aerobic biofilm attached to the membranes, and the produced nitrate is denitrified by the remaining WAS using the soluble organic matter also generated by hydrolysis. The combined two processes create an effect of simultaneous nitrification and denitrification in one volume while the WAS is being hydrolyzed and thus stabilized. It is noted that the longer the WAS is retained in the treatment tank, the higher is the degree of hydrolysis, and in turn, more ammonium compounds and organic matter are available for the simultaneous nitrification and denitrification process; thereby reduction of the VSS concentration is achieved, resulting in an aerobically treated sludge which is safe for release to the environment.

In some embodiments, retention of the WAS in the treatment tank may be for a period of at least about 5 days.

In other embodiments, the WAS is retained in the treatment tank for a period of time of between about 5 days and 30 days. In some other embodiments, the WAS is retained in the tank for a period of time of between about 7 days and 30 days, between about 10 days and 30 days, between about 15 days and 30 days, or even between about 20 days and 30 days. It is also noted that in some cases, when VSS removal requirements are high or other conditions such as sludge properties or low temperature are relatively difficult, the WAS retention time can be longer than 30 days. The required retention time for stabilization of the WAS in a process of the present disclosure is designed according to process parameters such as temperature, requirements for VSS removal and initial WAS composition.

The method disclosed herein aims at reducing the VSS concentration in the WAS from an initial VSS concentration, which is typically a concentration higher than permitted by various environmental standards and Regulations, to a VSS concentration that is sufficiently low to permit safe release of the aerobically treated sludge to the environment. Thus, the method results in a significant reduction in VSS concentration, namely a reduction of the concentration of VSS to or below a desired value, typically defined by local standards and/or local Regulations. For example, as defined in US Regulation 40 CFR part 503, reduction of at least 38% in VSS concentration in WAS is required in order for the WAS to be considered safe for release to the environment. Another example is the Israeli Ministry of Environment Protection guidelines, which also requires reduction of at least 38% in VSS concentration in WAS.

The term substantial reduction in the context of the present disclosure relates to a significant part or full compliance with the local Regulations requiring reduced VSS concentration in WAS. A person versed in the art would know how to locate the local Regulations regarding acceptable levels of VSS in treated sludge (WAS).

In order to increase the effective contact of the WAS with the biofilm, prevent settlement of WAS on the bottom of the tank and obtain optimal reduction in VSS concentration, the WAS is mixed in the treatment tank to cause circulation of the WAS in the proximity of the membrane(s).

Mixing may be carried out in at least a portion of the volume of the treatment tank. For example, mixing means can be operated selectively to mix portions of the tank's volume. Alternatively, the entire volume of the treatment tank may be mixed.

Mixing may be carried out by various mechanisms. In some embodiments, mixing is carried out by diffusing a gas, typically air, into the treatment tank. The gas diffusion typically involves introducing the gas into the tank, typically at the bottom portion of the tank. In order to maximize the mixing effect of the gas bubbles traveling through the treated medium (i.e. the WAS and its carrier medium, e.g. water, if such are present), the gas is released at a portion of the tank that is below the membranes (or below the MABR modules). This permits elongating the travel distance of the gas bubbles in the treatment medium, minimizes the settlement of WAS at the bottom of the tank, and allows the gas bubbles to travel in between the membranes, as to increase the mass transfer of nutrients from the treated medium to the biofilm, as well as metabolic products and oxygen from the water-facing surface of the membrane and/or the biofilm into the treated medium.

The introduction of gas into the treated medium is, by some embodiments, carried out by one or more gas diffusers, which may be positioned at a bottom portion (e.g. the bottom half or third volume portion) of the tank below the one or more membranes (or MABR modules).

Mixing may be carried out continuously, intermittently, or periodically. In case of intermittent or periodical mixing, for example by diffusion of gas into the treatment tank, gas (e.g. air) may be diffused into the tank in a mixing regimen, namely for defined periods of time, with defined time intervals therebetween. The duration of each mixing period and the length of the intervals in which mixing is not carried out are typically determined according to properties of the WAS (e.g. thickness) and characteristics of the system (for example dimensions of the tank, number of diffusers, number of MABR modules, etc.), with the purpose of obtaining a balance between effective mixing and maintaining the energy consumption of the system as low a possible. In other words, the duration of mixing and the duration of intervals should be tailored to maintain the WAS in a suspended state in the tank, without forming a thick and/or dense layer of settled WAS at the bottom of the tank, however also prevent unnecessary energy consumption as a result of too frequent mixing.

The mixing regimen may be constant throughout the duration of the mixing process, or may vary during the treatment process according to changes in various parameters measured throughout the process, as will be detailed below.

In some embodiments, air is diffused for about 10 to 120 seconds once every about 5 to 120 minutes. In other embodiment, air is diffused for periods of time of about 15 seconds to about 60 seconds, once every 10 to 60 minutes.

In other embodiments, the missing may be carried out by a pump that facilitates circulation of the treatment medium within the treatment tank. Suitable pumps may be, for example, a mechanical pump or an airlift pump. Circulation may be carried out continuously or intermittently.

It is noted that mixing may also be carried out depending change in one or more parameter of the treated medium, and/or in order to maintain one or more parameters of the treated medium in a certain range of values.

Hence the process may comprise sensing at least one parameter of the content of the tank (i.e. the treated medium, the carrier water and/or the WAS) by at least one sensor. The at least one sensor can be positioned within the treatment medium (i.e. at various locations in the treatment tank), at a WAS inlet feed and/or at an outlet of the tank. Various parameters may be measured during the treatment process, for example the at least one parameter may be at least one of ammonia concentration, nitrate concentration, oxidation-reduction potential (ORP), etc.

The method may comprise transmitting the readings of the one or more sensors to a control unit, in which the readings are processed. Transmittance of data may be carried out wirelessly or by wired means. The control unit, based on the processed readings, can then modify one or more mixing conditions, for example mixing frequency, mixing duration, and/or mixing intensity.

The WAS may be subject to one or more pre-treatments before feeding into the treatment tank. In some embodiments, the method may comprise concentrating the WAS before feeding it into the treatment tank. In other embodiments, the method may comprise diluting the WAS with a carrier liquid (e.g. water) before feeding it into the treatment tank. In some other embodiments, the WAS is de-watered before feeding it into the treatment tank.

In other embodiments, the WAS is thickened before feeding it into the treatment tank. Such thickening may increases the concentration of VSS in the WAS by up to about 2 wt % before introducing it into the treatment tank.

The method may also comprise post-treatments of the aerobically treated sludge. In some embodiments, the method comprises gravitationally thickening the aerobically treated sludge. Thickening may be carried out within the treatment tank, or in a thickening unit that is in flow-communication with the treatment tank. When thickening of the aerobically treated sludge is carried out within the treatment tank, the thickening may be carried out in a thickening volume of the treatment tank (e.g. the bottom of the tank), which is not exposed to the mixing conditions. This permits the aerobically treated sludge to settle and be collected.

Thickening and/or collecting may be carried out intermittently or continuously.

According to some other embodiments, the aerobically treated sludge may be dewatered after its collection. Dewatered aerobically treated sludge may then be further processed, e.g. undergo composting.

As used herein, the term “about” is meant to encompass deviation of ±10% from the specifically mentioned value of a parameter, such as temperature, pressure, concentration, etc.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic representation of a system for operating in a method according to an embodiment of this disclosure.

FIG. 2 shows ammonium (NH₄⁺) and nitrite (NO₃⁻) concentrations in the treated medium during a digestion process of WAS in a method according to an embodiment of this disclosure.

### DETAILED DESCRIPTION OF EMBODIMENTS

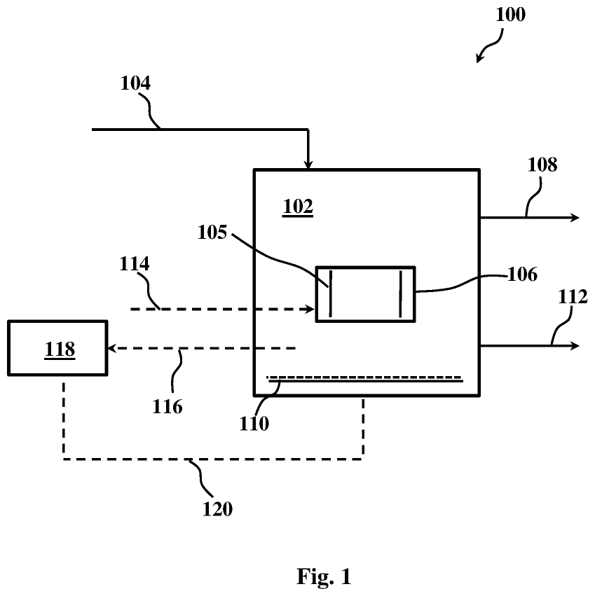

Turning to FIG. 1, shown is a system in which a method according to the present disclosure may be operated. System 100 comprises a treatment tank 102, which may be rectangular or cylindrical tank of any suitable material such as steel, polymer or concrete.

Waste activated sludge (WAS), such as WAS from primary and/or secondary wastewater treatment systems, is fed into the treatment tank via WAS inlet conduit 104. At least one MABR module 106 that contains an oxygen-permeable, water-impermeable membrane 105 is positioned in the tank 102. The number of membranes/modules may be determined by the VSS load in the WAS, the amount of WAS to be treated, and/or by oxygen transfer rate properties of the membrane(s).

Oxygen requirement for removal of VSS from WAS may be estimated according to established methodologies in the field; however, a common rule of thumb is that oxygen requirement is approximately 2 mass unit per each mass unit of VSS removed. The oxygen permeability of the membrane in terms of g/d/m² is used to determine the surface area of membrane required to provide the oxygen demand produced by endogenous decay of solids in the sludge.

The volume of tank 102 may be determined according to established methodologies in the field of wastewater treatment. The WAS fed into the tank is retained in the tank for a period of time sufficient to induce sufficient hydrolysis and digestion of the WAS, thus reducing the VSS concentration below a desired level. In the methods of this disclosure, the retention time is at least 5 days, typically in the range 20-30 days for about 40%-45% reduction in VSS concentration, depending on temperature.

Table 1 shows an example for calculation of the required tank volume, the required membrane area and the volume fraction of the tank occupied by the MABR modules.

TABLE 1
Example for a calculation of membrane volume ratio
A) Required Tank Volume

| | |
|---|---|
| Q (m³/day) | 100 |
| VSS in (mg/L) | 20,000 |
| Temp (° C.) | 25 |
| SRT × T(° C.) | 475 |
| SF | 10% |
| SRT (days) | 20.9 |
| Calculated Tank Volume (m³) | 2,090 |

B) Oxygen Requirements

| | |
|---|---|
| VSS reduction requirement | 45% |
| VSS removed (mg/L) | 9,000 |
| VSS removed per day (kg/day) | 900 |
| Specific oxygen req. (kgO₂/kgVSS) | 1.5 |
| Oxygen demand (kg O₂/day) | 1,350 |

C) Membrane fill ratio calculation

| | |
|---|---|
| membrane permeability (g/d/m²) | 12 |
| required membrane surface area (m²) | 112,500 |
| membrane packing factor (m²/m³) | 110 |
| membrane volume (m³) | 1,023 |
| Fill ratio | 49% |

SRT = solids retention time

The mechanism of oxidation within a tank is typically explained as follows: oxygen from a oxygen-containing gas that is fed to the membrane in the MABR module 106 through oxygen-containing gas line 114, which may be coupled to an air delivery means, such as a blower or a suction system (not shown). The oxygen diffuses through the membrane, to support development of a biofilm on the water-facing surface of the membrane, oxidizing ammonium compounds present in the WAS; biomass remaining in the WAS use the nitrate produced in the nitrification process to oxidize organic material. Thus, the concentration of ammonium compounds and organic material is reduced.

Biological activity in tank 102 is associated with the endogenous decay of the bacteria in the WAS. Sufficient membrane surface area is provided to satisfy the endogenous respiration rate of the WAS. The endogenous respiration rate can be measured in a respiration test such as described in “Respirometry in Control of the Activated Sludge Process: Priciples” by Spanjers, Vanrolleghem, Olsson, Dold (IAWQ Task Group on Respirometry) 1998. Alternatively, the predicted endogenous respiration rate and corresponding oxygen requirements can be calculated according to parameters known in the field of wastewater treatment, such as published in Metcalf & Eddy (2003) Wastewater Engineering: Treatment and Reuse, pp. 1535-1539, 4th Edition, McGraw-Hill, New York.

The WAS is mixed during its retention in the tank by air diffusers 110, that are positioned at the bottom of tank 102. Air may be supplied to diffusers 110 through piping connected to a pressurized air source (not shown), such as a blower. The diffusers 110 may be operated intermittently, for example by turning the blower on and off or by operating a valve connected to a source of pressurized air, or by means of an air accumulator.

One or more sensors may measure various parameters in the tank, such as ammonia concentration, nitrate concentration and oxidation-reduction potential (OPR) and the readings may be transmitted though communication line 116 (which may be wireless or wired) to control unit 118. Control unit 118 may process the readings and issue commands to modify one or more mixing parameters—the commands being delivered to the diffuser 110 through communication line 120 (which may be wireless or wired). Thus, the mixing conditions may be modified throughout the treatment process in order to obtain a desired VSS reduction and/or to maintain or stabilize various conditions in the treatment tank.

Aerobically treated sludge is discharged from the tank via outlet conduit 112. In case thickening is carried out within the tanks 102, thickened sludge is discharged through outlet conduit 112 and supernatant is discharged from an upper supernatant outlet 108.

Aerobically treated sludge may be dewatered in a separate process unit such as a centrifuge or belt press (not shown). Dewatered sludge is discharged for reuse or additional processing according to local Regulations. Supernatant water from the dewatering process is typically returned to the wastewater treatment process from which the sludge was drawn for treatment.

Thickening is typically performed in either a gravity thickener or a mechanical thickener. Optionally, chemicals are added to aid in the thickening such as flocculating agents or coagulants, as part of the thickening process.

### EXAMPLE

WAS from the bottom of a secondary clarifier was fed continuously by a pump from a feed tank into a treatment tank at a feed flow rate of 175 liter/day. The tank had a volume of 3.4 m³, with water depth of about 2.5 m. The tank was fitted with a spirally wound MABR module with surface area of 475 m². Air diffusers were disposed in the tank below the MABR module to enable mixing of the WAS; mixing was carried out by intermittent air sparging from a blower through the coarse bubble diffusers every 30 seconds, 4 times per hour (every 15 minutes). Low pressure air from a fan was provided continuously to the MABR to provide air to the membrane. Retention time of the WAS in the tanks was about 20 days in continuous feed mode.

Samples of the WAS from the tank inlet and samples of the treated sludge from the tank's outlet were taken 2-3 times per week. TSS (total soluble solids) and VSS (volatile soluble solids) analysis was carried out according to Standard Methods for Examination of Water and Wastewater, 23rd edition, Author: E. W. Rice, R. B. Baird, A. D. Eaton, Publisher: American Public Health Association, American Water Works Association, Water Environment Federation. The analysis included filtering of pre-determined volumes of the taken sample, the filter cakes were dried at 105° C. to determine TSS, then cooked at 550° C. to determine VSS by difference. The % VSS removal was calculated according to: (VSS_{IN}-VSS_{OUT})/VSS_{IN}. The test results are shown in Table 2. The test was run for several months to obtain steady state conditions, and the results presented in Table 2 were obtained after about 3 months of continuous operation.

TABLE 2
test results

| | | | | | VSS |
|---|---|---|---|---|---|
| Day of | TSS IN | VSS IN | TSS OUT | VSS OUT | reduc- |
| operation | [mg/l] | [mg/l] | [mg/l] | [mg/l] | tion |
| 112 | 27,322 | 23,816 | 9,644 | 7,706 | 68% |
| 114 | 29,988 | 25,840 | 8,750 | 6,749 | 74% |
| 115 | 27,916 | 24,200 | 9,352 | 7,416 | 69% |
| 119 | 30,337 | 26,277 | 9,311 | 7,400 | 72% |
| 121 | 29,157 | 25,115 | 9,602 | 7,540 | 70% |

The test results show that VSS reduction in the range 68-74% was obtained at about 20 days retention time in continuous feed mode. Comparing to the regulatory requirements in the USA (according to 40 CFR part 503), which requires minimum of 38% VSS reduction to permit safe release to the environment, the present results significantly exceed (in the specific example in about 2-folds) the % reduction of VSS required by the Regulation.

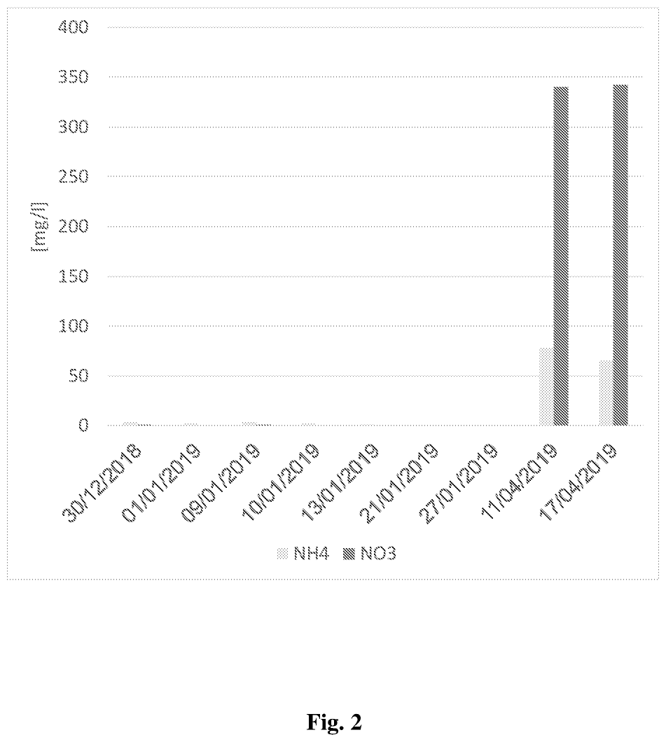

FIG. 2 shows ammonia and nitrate concentrations in the filtered water from the treated sludge during the same period as the example, as well as later results obtained at a later time without a MABR in the tank. It can be seen that in January, with the MABR in the tank, both ammonia and nitrate concentrations are low, indicating that hydrolyzed nitrogen was substantially removed. On the other hand, in April without the MABR in the tank, only part of the ammonia was oxidized to nitrate as a result of which both constituents are much higher.

1. A method for treating waste activated sludge (WAS), the method comprising:
feeding WAS into a treatment tank, the WAS having an initial volatile suspended solids (VS S) concentration, the treatment tank comprising one or more oxygen-permeable water-impermeable membranes, said membranes being configured for supporting biofilm growth thereon;
feeding an oxygen-containing gas into said one or more oxygen-permeable water-impermeable membranes to provide oxygen to at least a portion of the biofilm, while maintaining the WAS under anoxic condition; and
mixing the WAS in the treatment tank to cause circulation thereof in proximity to the one or more oxygen-permeable water-impermeable membranes and retaining the WAS in the tank for a period of time permitting substantial reduction of said initial VSS concentration, thereby obtaining an aerobically treated sludge.

2. The method of claim 1, wherein the WAS is retained in the tank for a period of time of at least about 5 days or for a period of time between about 5 days and about 30 days.

3. (canceled)

4. The method of claim 1, wherein one or more membrane-aerated biofilm reactor (MABR) modules are positioned in the tank, each of said one or more MABR modules comprises one of said one or more oxygen-permeable water-impermeable membranes, and each of said MABR modules occupies a portion of the tank's volume.

5. The method of claim 1, wherein said mixing of the WAS is carried out within tank in at least a portion of the tank's volume and/or by diffusing air into the tank.

6. (canceled)

7. The method of claim 5, wherein the air diffusing is intermittent or periodical.

8. The method of claim 7, wherein air is diffused for about 10 to 120 seconds once every about 5 to 120 minutes.

9. The method of claim 6, wherein the air is diffused into the tank by at least one diffuser, wherein said at least one diffuser is positioned at a bottom portion of the tank.

10. (canceled)

11. The method of claim 9, wherein said at least one diffuser is positioned below the one or more oxygen-permeable water-impermeable membranes.

12. The method of claim 9, wherein one or more membrane-aerated biofilm reactor (MABR) modules are positioned in the tank, each of said one or more MABR modules comprises one of said one or more oxygen-permeable water-impermeable membranes, and each of said MABR modules occupies a portion of the tank's volume, and said at least one diffuser is positioned below the MABR modules.

13. (canceled)

14. The method of claim 1, comprising sensing at least one parameter of the content of the tank by at least one sensor positioned in the tank, wherein at least one parameter of the content of the tank is at least one of ammonia concentration, nitrate concentration and oxidation-reduction potential (ORP).

15. (canceled)

16. The method of claim 15, comprising modifying at least one mixing condition according to a sensed value of said at least one parameter, wherein said mixing condition is at least one of mixing frequency, mixing duration and mixing intensity.

17. (canceled)

18. The method of claim 1, wherein the WAS is received from a wastewater treatment system or process.

19. The method of claim 1, wherein the WAS is received from a primary clarifier and/or secondary clarifier.

20. The method of claim 1, wherein the WAS is concentrated or thickened WAS.

21. The method of claim 1, wherein said oxygen-containing gas is fed to said membrane at a pressure that is lower than the hydrostatic pressure of sludge in the tank.

22. The method of claim 1, also comprising collecting the aerobically treated sludge from a bottom part of the tank.

23. The method of claim 1, comprising gravitational thickening of the sludge within the tank.

24. (canceled)

25. The method of claim 22, wherein thickening and collecting are carried out continuously or periodically.

26. (canceled)

27. The method of claim 25, wherein mixing is carried out intermittently or periodically followed by time intervals in which no mixing is carried out, said thickening and collecting are carried out in said time intervals.

28. The method of claim 22, comprising dewatering the aerobically treated sludge after collection.
